(19) United States
(12) Patent Application Publication
(10) Pub. No.: US 2003/0060215 A1
(43) Pub. Date: Mar. 27, 2003

(54) System and method for displaying subscriber locations on mobile stations

(76) Inventor: Tyrol R. Graham, Seattle, WA (US)

Correspondence Address: SCHWABE, WILLIAMSON & WYATT, P.C., 10260 SW GREENBURG ROAD, SUITE 820, PORTLAND, OR, 97223, US

(21) Appl. No.: 10/256,683

(22) Filed: Sep. 27, 2002

Related U.S. Application Data
(60) Provisional application No. 60/325,873, filed on Sep. 27, 2001.

(51) Int. Cl. H04Q 7/20

(52) U.S. Cl. 455/456; 455/432

(57) ABSTRACT

A system for indicating the presence and locations of subscribers in a geographic area for wireless mobile stations includes a subscriber locator that provides the wireless mobile stations with a displayable image. The subscriber locator interoperates with a subscriber database of a cellular telephone service provider that services the geographic area. The subscriber database can be a HLR and/or VLR. The displayable image utilizes pixels of the wireless mobile station in a functional dependent manner, on the presence and locations of subscribers within the geographic area. The displayable image can include an indication of a landmark.

### RELATED APPLICATION

The present application is the non-provisional application of provisional application No. 60/325,873, filed Sep. 27, 2001, and titled “System and Method for Displaying Subscriber Locations Using a Mobile Station”, which specification is hereby fully incorporated by reference.

### FIELD OF THE INVENTION

This disclosure relates generally to wireless communication systems, and in particular but not exclusively, relates to providing presence and locations of subscribers of wireless communication systems to subscribers of the systems on the subscribers' wireless mobile stations.

### BACKGROUND OF THE INVENTION

Cellular telephone systems allow a subscriber to make and receive telephone calls wirelessly using a wireless mobile station (MS) such as a wireless cellular telephone. As used herein, a cellular telephone system may be any suitable wireless communication system that can transmit and receive calls with a public switched telephone network (PSTN). Many such systems currently exist; e.g., analog and digital cellular systems such as TACS (total access communication system), NMT (Nordic mobile telephone system), ADC (American digital cellular system), GSM (global system for mobile communication), PCS (personal communication service) and others.

Typically, a cellular telephone service provider has a system of base stations (BSs) and mobile switching centers (MSCs) that define “cells” over a geographic area that the service provider will provide cellular telephone service. As a MS moves from one cell to another, the cellular telephone system updates a record of the MS's current cell location and can “handoff” an in-progress telephone to a newly entered cell. This type of location information is typically stored in a database that can be accessed by MSCs, which allows the system to properly create connections between the PSTN and the MSs. However, in existing cellular telephone systems, this location information is typically not accessible by the subscriber through the subscriber's MS. Moreover, existing cellular telephone systems typically do not allow subscribers to access location information of other subscribers.

But, in a number of situations, subscribers are interested in knowing presence and location information of other subscribers, in particular, in receiving such information on their wireless mobile stations. Thus, a method for providing presence and locations information of subscribers of a wireless communication system to subscribers with interest, on the subscribers' mobile stations, is desired.

### SUMMARY OF THE INVENTION

In accordance with aspects of the present invention, a system is provided for indicating presence and locations of subscribers of a wireless communication system in a geographic area on a subscriber's wireless mobile station.

In one aspect of the present invention, the system includes a subscriber locator and wireless mobile stations of subscribers of the wireless communication system.

In one embodiment, the location subscriber is configured to provide a subscriber a displayable image conveying presence and locations of subscribers of a wireless communication system for a geographic area, for display on the subscriber's wireless mobile station.

In another aspect, the subscriber locator interoperates with a subscriber database operated by a cellular telephone service provider that services the geographic area to obtain the presence and locations information of subscribers within a geographic area, and generates a displayable image based on the presence and location information obtained.

In one embodiment, the subscriber database can be a HLR (home location register). In another embodiment, the subscriber database may also include a VLR (visitor location register).

In operation, the subscriber locator accesses the HLR and/or VLR for the number of subscribers in each cells associated with the geographic area. Based on the HLR and/or VLR data, the subscriber locator then generates the displayable images for the subscribers (in advance or dynamically, on demand), and provides the generated displayable images to the subscribers for display on their wireless mobile stations.

In one embodiment, the subscriber locator processes the accessed information, including aggregating the obtained location information. For these embodiments, the displayable image conveys aggregated presence and locations of the subscribers of the wireless communication system in the geographic area.

In one embodiment, the displayable image is rendered using a number of pixels of the wireless mobile station. The pixels are used in a functional dependent manner, depending on the presence and locations of subscribers in the geographic area.

In one embodiment, the quantity of pixels illuminated is functionally dependent on the presence and locations of subscribers of the wireless communication system. In another embodiment, the colors of the illuminated pixels are functionally dependent on the presence and locations of the subscribers of the wireless communication system.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a block diagram illustrating a system for displaying subscriber location, according to one embodiment of the present invention;

FIG. 2 is a diagram illustrating in more detail a portion of the system depicted FIG. 1, according to one embodiment of the present invention;

FIG. 3 is a flow diagram illustrating the operation of the system depicted in FIG. 1, according to one embodiment of the present invention;

FIG. 4 is a flow diagram illustrating the operational flow of determining subscriber locations, according to one embodiment of the present invention; and

FIG. 5 is a block diagram of a MS displaying a subscriber location map according to one embodiment of the present invention.

### DETAILED DESCRIPTION OF EMBODIMENTS OF THE INVENTION

The present invention includes a system and method for providing subscribers of a wireless communication system with presence and location information of subscribers within a geographic area, on the wireless mobile stations of the subscribers.

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will be apparent to one skilled in the art that the present invention may be practiced without the specific details. In other instances, well-known features are omitted or simplified in order not to obscure the present invention.

Parts of the description will be presented in wireless mobile telephony terms, such as data, flag, transmit, receive, and so forth, consistent with the manner commonly employed by those skilled in the art to convey the substance of their work to others skilled in the art. As well understood by those skilled in the art, these quantities take the form of electrical, magnetic, or optical signals capable of being stored, transferred, combined, and otherwise manipulated through electrical and/or optical components of a processor and its subsystems.

Part of the descriptions will employ various abbreviations, including but are not limited to:

| | |
|---|---|
| BS | Base Stations |
| HLR | Home Location Register |
| MS | Mobile Station |
| MSC | Mobile Switching Center |
| PSTN | Public Switching Telephony Network |
| SMS | Small Messaging Service |
| VLR | Visitor Location Register |

The term “wireless mobile station” as used herein (in the claims as well as in the specification) includes but are not limited wireless mobile “handsets” having wireless mobile telephony capability that allows a user of a “handset” to communicate with a callee, as long as the user is within transmission reach of a base station of a wireless telephone service network. The user may be stationary or mobile. The term as used includes the conventional “handsets” as well as “handsets” that are digital computing devices equipped with wireless mobile telephony capability, such as a personal digital assistant (PDA) or palm-sized computer so equipped.

Various operations will be described as multiple discrete steps in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

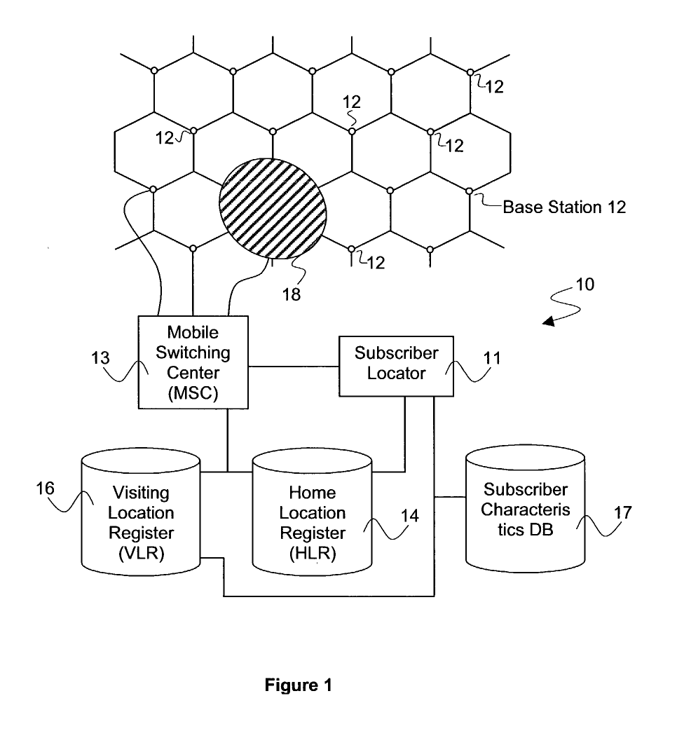

FIG. 1 illustrates a subscriber location system 10, according to one embodiment of the present invention. In one embodiment, subscriber location system 10 includes a subscriber locator 11 that interoperates with a set of base stations (BSs) 12, a mobile switching center (MSC) 13, and a home location register (HLR) 14. In addition, subscriber locator 11 may interoperate with a visitor location register 16.

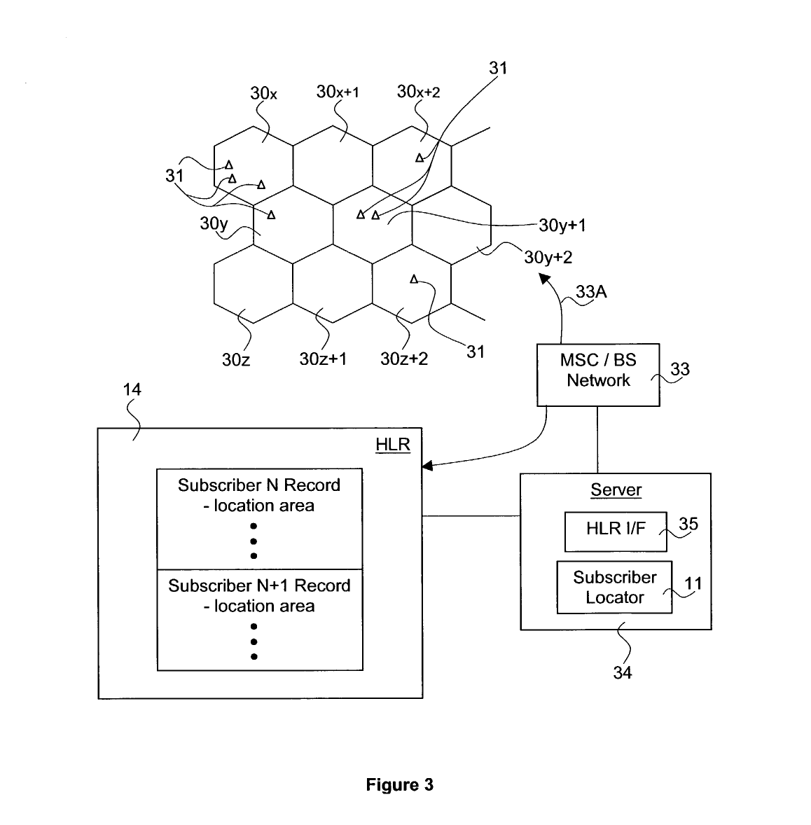

A software implementation of subscriber locator 11 is described below in conjunction with FIG. 3. In alternate embodiments, all or a portion of subscriber locator 11 may be implemented in hardware.

A cellular telephone service provider operates BSs 12, MSC 13, HLR 14, and VLR 16 to provide cellular service to a coverage area. HLR 14 can maintain a database of subscribers based in the coverage area. VLR 16 can maintain a database of subscribers based in other coverage areas that have entered the coverage area associated with HRL 14. In some embodiments, VLR 16 is implemented as part of MSC 13. MSC 13 interfaces with BSs 12, HLR 14 and VLR 16 to manage the link between mobile stations (MSs) and the public switched telephone network (PSTN) in connecting telephone calls. BSs 12 are typically implemented as radio frequency (RF) transceivers that interoperate with MSs.

The elements depicted in FIG. 1 are interconnected as follows. Subscriber locator 11 is connected to MSC 13, HLR 14 and, optionally, to VLR 16. MSC 13 is connected to the set of BSs 12, which are distributed over a geographic area as in standard cellular telephone systems. The geographic area may be a portion of a city or a metropolitan area that is covered by the cellular telephone service provider that operates MSC 13 and BSs 12.

BSs 12 help define cells of the cellular telephone system. These cells are represented as hexagons in FIG. 1. As used herein, the term “cell” can also include microcells that result from sectorizing a cell.

As will be appreciated by those skilled in the art, cells are not typically hexagonal; rather, cells have sizes and shapes that can depend on a number of factors such as the expected number of calls, obstructions such as topography, buildings and the like, and the placement and alignment of BSs, etc. In exemplary FIG. 1, the geographic area includes a selected landmark (e.g., a park). This landmark is represented in FIG. 1 as a shaded region 18. The selected landmark or landmarks may be of any size and nature such as, for example, mountain or hill, a body of water, a well-known building, monument, park, tourist attraction, structure, arena, stadium, campus, shopping mall etc.

In general, system 10 determines presence and locations of subscribers in a geographic area and provides information related to the locations of the subscribers within the geographic area to a subscriber for display on the subscriber's wireless mobile station. The geographic area may be the same, a subset or a superset of the geographic area of interest to a subscriber.

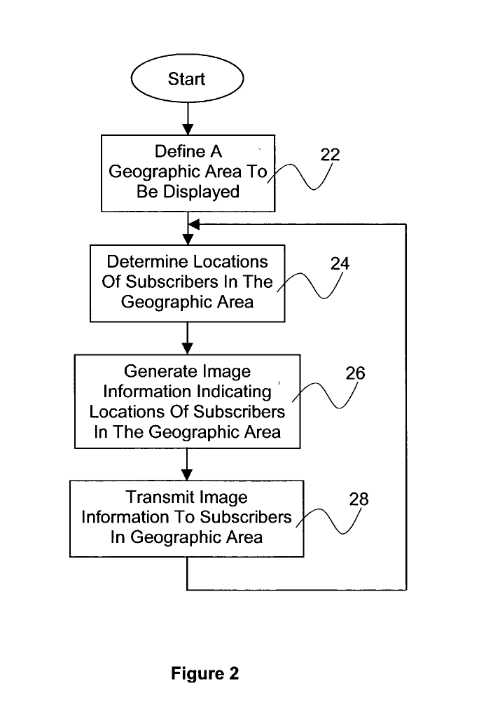

As used in this context, the term “subscriber location” typically refers to the location of a subscriber's MS. In one embodiment, the location information is in the form of an image or map that can be displayed by the subscribers' MSs. The operation of system 10 is described further below, in conjunction with FIG. 2.

FIG. 2 is illustrates the operation of system 10 (FIG. 1 ), according to one embodiment of the present invention. Referring to FIGS. 1 and 2, this embodiment of system 10 operates as follows.

In block 22, one or more geographic areas are selected. In one embodiment, the cellular telephone service provider pre-selects the geographic area(s). In alternate embodiment, the geographic areas may be provided by the subscribers instead.

In various embodiments, provisions of the geographic areas by the subscribers may be facilitated by presenting a list of geographic areas by name on the MS of the subscribers for the subscribers to select, or presenting an array of geographic area icons on the MS for the subscribers to select. In other embodiments, provision of the geographic areas by the subscribers may be facilitated by having the subscribers select the geographic areas by specifying their boundaries, or critical vertices. In the latter case, a geographic area may be defined by automatically joining the adjacent critical vertices, using e.g. straight lines, to form the boundaries of the geographic area.

In block 24, the presence and locations of subscribers within the one or more geographic areas are determined. In one embodiment, subscriber locator 11 determines presence and locations by accessing HLR 14 to obtain the stored cell location information of each MS in the geographic area. In an alternative embodiment, subscriber locator 11 can also access VLR 16 to obtain presence and location information of visiting subscribers (i.e., being associated with HLRs different from HLR 14), if any, that have entered cells covering the geographic area.

In block 26, a displayable image for each geographic area is created that indicates presence and locations of subscribers within the geographic area. In one embodiment, subscriber locator 11 for example, processes subscriber information obtained from HLR 14 to determine the number of MSs, if any, in each cell covering the geographic area. In an alternative embodiment, subscriber locator 11 also processes subscriber information obtained from VLR 16 in determining the number of MSs in each cell.

In alternate embodiments, the processing may include aggregating the presence and information. In other words, the subsequent generated displayable images convey the presence and location information for corresponding geographic areas in an aggregated form.

Subscriber locator 11 can then create the image with an indication of the locations of subscribers in the geographic area. For example, in one embodiment, subscriber locator 11 can map a geographic sub-area (e.g., a cell or groups of cells) of the geographic area to a portion of the image to be displayed by the MSs. In other embodiments, subscriber locator 11 can create images for more than one geographic area (see block 22) using the same information accessed from HLR 14 in block 24. Alternatively, block 24 may be performed separately for each different geographic area.

For the embodiments where the geographic areas are pre-selected by the service provider, the determination of the presence and location information, and the generation of the displayable images may be pre-performed before a subscriber requests for the presence and location map of one of the pre-selected geographic areas. In other embodiments where the geographic areas are dynamically provided by the subscribers via one of the above described or like approach, the determination of the presence and location information, and the generation of the displayable images may be performed in real time, responsive to the subscribers' requests.

Further, in various embodiments, the service providers or the subscribers may specify other subscriber selection criteria, e.g. one or more demographic metrics (age, sex, and so forth), and the determination of presence and location information, and the generation of the displayable image may further include only subscribers that match the specified subscriber selection criteria.

In various embodiments, a displayable image is rendered using a plurality of pixels, with subsets of the pixels corresponding to sub-areas of the geographic area. Various techniques can be used to indicate the number of subscribers in each of the geographic sub-areas. For example, the image may be a bitmap image. Each portion of the bitmap image can be represented by a preselected number of pixels of a display device (e.g., a LCD) on each MS. The number of subscribers in a geographic sub-area can be indicated by appropriately activating pixels in the corresponding portion of the image. In one embodiment, the number pixels (corresponding to an area) that are activated is a function of the number of subscribers in the corresponding area. More specifically, in one embodiment, the number of activated pixels increases as the number of subscribers in the corresponding area increases, up to the maximum number of pixels corresponding to the area. Note that the phrase “activating a pixel” is a relative term. This phrase generally means changing the pixel to a state that is different from the background. Depending on the background, activating a pixel could mean changing the pixel to be black, white, or another color. Making the pixels “blink” is another way to indicate the density of subscribers.

In the example of Table 1, more than 20 subscribers might cause the corresponding pixels to blink slowly, and more than 50 subscribers might cause the pixels to blink rapidly. In addition, different colors can be used to show density. Therefore, starting with white, the pixels in an area might change to yellow, green, and red, to show increasing density. Table 1 lists the number of pixels to be activated in an exemplary embodiment having four pixels per image portion.

TABLE 1

| No. of Subscribers in Sub-Area | No. of Pixels Activated in Image |
|---|---|
| (Density) | Portion |
| 0 | 0 |
| 1-3 | 1 |
| 4-8 | 2 |
| 9-11 | 3 |
| 12 or more | 4 |

In another embodiment, the number of subscribers corresponding to an activated pixel may vary according to the total number of subscribers that exist or the number of subscribers currently detected as having their devices turned on within the geographic area. Therefore, this may change by the hour, or each time an image is updated. In this alternative embodiment, a table is created similar to Table 1 above except that the subscriber density ranges change (i.e., the first column of Table 1) so that the total number of activated pixels in the display screen is maintained within a desired range. If all pixels are activated, or if only a very small number are activated, the resulting image may not effectively convey the subscriber density information. In one embodiment, the table is maintained so that between 20% and 50% of pixels are activated. In addition, in some embodiments, the image may also be created to show a landmark that is present in the geographic area. For example, the landmark may be a mountain or hill, a body of water, a well-known building or stadium, etc. The image is created with subscriber locations positioned relative to the landmark, which can help subscribers in finding subscribers. In one embodiment, subscriber locator 11 may create the image with an outline of the landmark.

In block 28, information for displaying the image (see block 26) is provided to MSs in the geographic area. In one embodiment, subscriber locator 11 provides this image information to MSC 13. For example, the image may be a bitmap. In other embodiments, for example, the image information may be compressed image data that can be decompressed by subscribers' MSs. In yet other embodiments, the image information may be data that indicates the changes in the image relative to the previously transmitted image.

MSC 13 then causes BSs 12 to transmit the image information to MSs in the geographic area, which can then be received by the MSs and displayed. In one embodiment, data is transmitted/broadcast to MSs, and the MS creates an image from the data. This has an advantage in that different MSs may have different screens. For example, some screens display images in color, black and white, high resolution, low resolution, etc. By having the MS create the image, the MS can do it according to the screen's resolution, colors, etc. Also, in an alternative embodiment, a browser is included in the MS. In this alternative embodiment, images are received from a Web server using a WAP protocol for display using the browser (so no special programming is required in the MS).

In one embodiment, MSC 13 may cause individual messages containing the image information to be transmitted to each MS in the geographic area. In an alternative embodiment, the MSs may be configured to receive broadcast messages. In this context, a broadcast message is one that several subscribers' MS may receive as opposed to a message that is transmitted for receipt by a single intended MS. The messages can be transmitted as SMS messages or using other wireless transmission technologies. The data may also be sent using WAP protocols, which can be advantageously used by MS's that have browsers. The operational flow then returns to block 24 to provide updated subscriber location information to subscribers' MSs.

This embodiment can be advantageously used by subscribers that have common interests. For example, a large concentration of subscribers at a particular location can indicate that there is an event at that location that a user may also be interested in attending.

Other embodiments of the present invention may use different database(s) for tracking the location of MSs. In accordance with the present invention, the MSs do not need to use GPS technology. Further, by using the information of HLR 14, the MSs do not need the capability of determining their own locations. Thus, embodiments of the present invention work with existing MSs.

FIG. 3 illustrates in more detail a portion of system 10 depicted in FIG. 1, according to one embodiment of the present invention. In this embodiment, a large number of cells are needed to cover the geographic area. For example, the geographic area may be about twenty square miles. FIG. 3 shows a subset of the cells used to cover the geographic area; namely, cells 30_{X}, 30_{X+1}, 30_{X+2}, . . . , 30_{Y}, 30_{Y+1}, 30_{Y+2}, . . . , 30_{Z}, 30_{Z+1} and 30_{Z+2}. Several mobile stations (MSs) 31 are distributed throughout the cells. For example, cell 30_{X} has three MSs, cell 30_{X+1} has no MSs, and cell 30_{X+2} has one MS. For improving clarity, the MSCs and BSs are indicated by a block 33, with an arrow 33A indicating that one or more MSCs and BSs are distributed across the geographic area.

Further, in this embodiment, subscriber locator 11 resides in a server 34 (server 34 may be implemented using more than one server). Server 34 also includes an interface 35 to HLR 14 that allows server 34 to access information stored by HLR 14. HLR 14 can include records of subscriber information, including the location area of each subscriber based in the area associated with HLR 14. For example, FIG. 3 illustrates a subscriber record 36_{N} for a subscriber N, a subscriber record 30_{N+1} for a subscriber N+1, and so on. Each subscriber record includes the most recently stored location area (e.g., cell location) for the associated subscriber. Such information is typically maintained in HLRs.

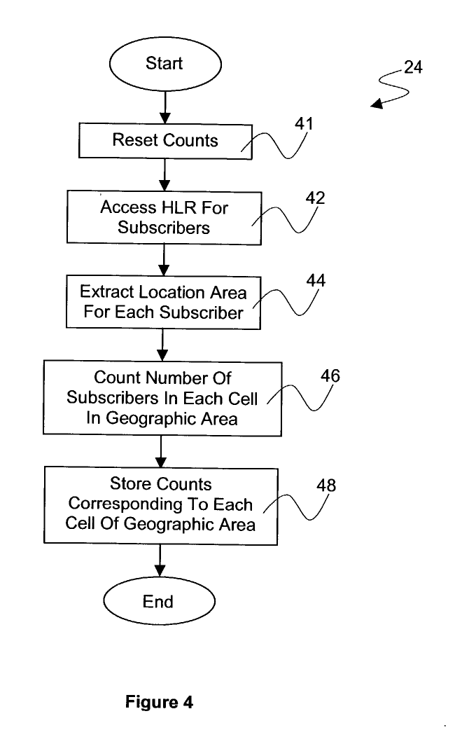

This embodiment of system 10 operates as described in conjunction with FIG. 2. More particularly, in this embodiment, the location information determined in step 24 (FIG. 2) is determined on a cell basis. That is, for each subscriber in the geographic area, system 10 determines the cell in which each subscriber is located. Further, in this embodiment, system 10 determines this location information from subscriber records 36_{N}, 36_{N+1}, and so on, which are stored in HLR 14. This operation is described in more detail below in conjunction with FIG. 4.

In an alternative embodiment, the subscriber locator service may be option that subscribers may elect. In such embodiments, subscriber records 36_{N}, 36_{N+1}, and so on, may include a field or flag (not shown) indicative of whether the subscriber associated with each record has opted for the subscriber locator service. Thus, in this alternative embodiment, a subscriber may opt out of getting subscriber location information and/or being included in the subscriber location information generated by subscriber locator 11.

FIG. 4 illustrates the operational flow of block 24 (FIG. 2), according to one embodiment of the present invention. Referring to FIGS. 3 and 4, block 24 (FIG. 2) can be performed as follows.

In block 41, counters that count the number of subscribers in each cell are reset. In one embodiment, subscriber locator 11, which may be implemented as a software process residing in server 34, maintains a counter for each cell in the geographic area. In this embodiment, subscriber locator 11 resets the counters to zero.

In block 42, HLR 14 is accessed to obtain location information. In one embodiment, subscriber locator 11, via interface 35 of server 34, accesses subscriber records 36_{N}, 36_{N+1}, and so on, for the cell location of each subscriber in the geographic area. For example, subscriber locator 11 may retrieve subscriber identification and subscriber location information for each subscriber record 36_{N}, 36_{N+1} and so on, from HLR 14 and store this retrieved information in server 34. In an alternative embodiment, subscriber locator 11 may retrieve only the subscriber records corresponding to subscribers whose most recently updated locations are in cells of the geographic area.

In block 44, the location information is processed to determine a location for each subscriber in the geographic area. In one embodiment, subscriber locator 11 processes the information retrieved in block 42 for the cell location of each subscriber in the geographic area. For example, subscriber locator 11 may extract a location from the cell location field of each retrieved subscriber record.

In block 46, the number of subscribers in each cell covering the geographic area is determined. In one embodiment, subscriber locator 11 processes the location information (from block 44) to determine the number of subscribers in each cell of the geographic area. For example, subscriber locator 11 may, for each subscriber record 36_{N}, 30_{N+1} and so on, determine the cell location stored for that subscriber record and then increment the counter (see block 41) corresponding to that cell. In this example, if the cell location of the accessed subscriber record were not within the geographic area, then none of the counters would be incremented.

In still other embodiments, the number of subscribers, if any, in each cell covering the geographic area can be determined using different methods or algorithms. For example, it the HLR database with a cell location field, an SOL or other database query could retrieve the number of subscribers in each cell.

In block 48, the number of subscribers in each cell of the geographic area is stored. In one embodiment, subscriber locator 11 stores this location information in memory (not shown) of server 34. For example, the counter value corresponding to each cell may be stored in an array structure. This information can then be easily accessed to generate the image of the geographic area (e.g., as described above in conjunction with block 26 of FIG. 2). The number of subscribers in a cell can be indicated as described above in conjunction with block 26 of FIG. 2. In other embodiments, the number of subscribers in a cell can be indicated by the number of times a pixel (or group of pixels) blinks in a predetermined time. In other embodiments in which the MSs have color display devices, the number of subscribers in a cell may be indicated using different colors. Other techniques can be used to indicate the number of subscribers that are in a cell.

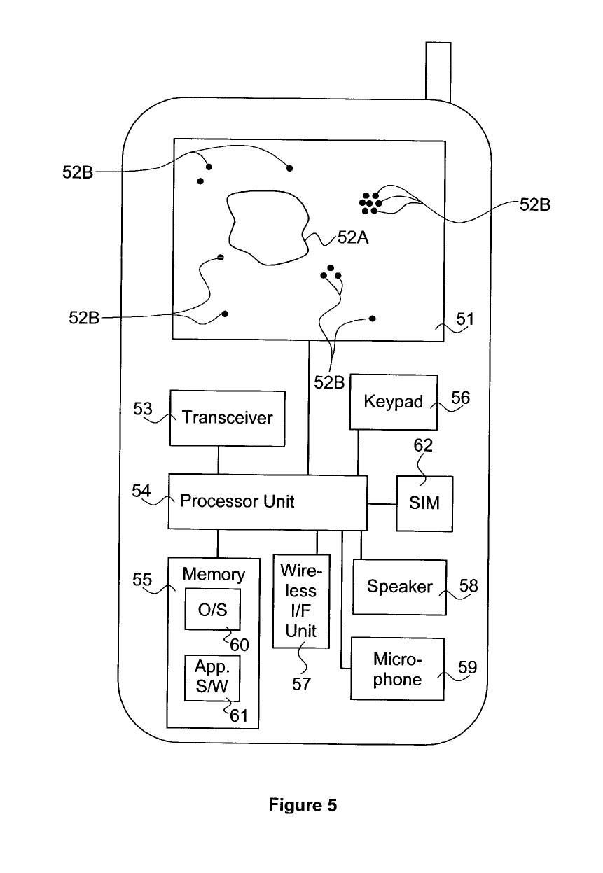

FIG. 5 illustrates a MS 31 displaying a subscriber location image, according to one embodiment of the present invention. In this embodiment, MS 31 includes a display device 51. In this exemplary figure, display device 51 displays a landmark 52A and the locations of several subscribers 52B. MS 31 can be implemented using a conventional MS with appropriate programming to process the location information described in block 26 (FIG. 1).

MS 31 also includes a transceiver 53, a processor unit 54, a keypad 55, a memory 56, a wireless interface unit 57, an audio speaker 58, a microphone 59, an operating system 60, application software 61 and, optionally, a subscriber identification module (SIM) 62. In this exemplary embodiment, operating system 60 and application software 61 are stored in memory 56.

In one embodiment, display device 51, transceiver 53, keypad 55 memory 56, wireless interface unit 57, audio speaker 58 and microphone 59 are connected to processor unit 54. Processor unit 54 sends and receives commands from operating system 60. Operating system 60, in conjunction with processor unit 54, controls application software 61.

In operation, this embodiment of transceiver 53 is used to receive messages in various formats such as, for example, short message service (SMS), code division multiple access (CDMA), time division multiple access (TDMA), global system for mobile communication (GSM), and general packet radio service (GPRS). Wireless interface unit 57 operates in conjunction with transceiver 53 to send and receive information. Audio speaker 58 can convert signals received from transceiver 53 to audio signals for users to hear. Display device 51 is used to display text and/or images for users to view. For example, display device 51 can be implemented with a LCD. Processor unit 54 can store received message information in memory 56. Processor unit 54 can also control display device 51 to display the stored message information or other data from memory 56. A user may use keypad 55 to input data and/or instructions to processor unit 54.

In one embodiment, MS 31 uses these elements to perform the functions of cellular telephone to make and receive telephone calls, SMS messages, etc. In addition, in accordance with the present invention, MS 31 can receive and process subscriber location information provided by subscriber locator 11 (FIG. 1) to display an image indicating the location of subscribers in a geographic area. In one embodiment, processor unit includes instructions to process received subscriber location information and display the image via display device 51. Thus, for example, MS 31 can receive an “image” message provided by subscriber locator 11 (FIG. 1) via MSC 13 and BSs 12 using transceiver. Processor unit 54 can store the image information in memory 56. Processor unit 54 can also process the image information to provide control signals to display device 51 to display the image. The subscriber may operate keypad 55 to control how and when processor unit 54 causes display device 51 to display information.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. In a computing environment, a method of operation:
receiving from a wireless mobile station a request for presence and locations of wireless communication subscribers for a first geographic area;
in response, performing one of
dynamically generating a displayable image that conveys presence and locations of wireless communication subscribers for a second geographic area substantially comprising the first geographic area, and
selecting a pre-generated displayable image that conveys presence and locations of wireless communication subscribers for a second geographic area substantially comprising the first geographic area; and
transmitting the dynamically generated/selected displayable image to the wireless mobile station for display on the wireless mobile station.

2. The method of claim 1, wherein said dynamic generation/pre-generation comprises
determining presence and locations of wireless communications subscribers within the second geographic area; and
generating the displayable image based on the determined presence and locations of wireless communication subscribers within the second geographic area.

3. The method of claim 2, wherein said determining comprises access a home location register of a wireless communication service provider providing wireless communication service for the geographic area.

4. The method of claim 2, wherein said determining comprises access a visitor location register of a wireless communication service provider providing wireless communication service for the geographic area.

5. The method of claim 1, wherein
said receiving further comprises receiving one or more subscriber selection criteria; and
said dynamic generating/selecting comprises dynamically generating/selecting the displayable image further based on the provided subscriber selection criteria.

6. The method of claim 1, wherein said dynamic generation/pre-generation comprises aggregating presence and locations of wireless communication subscribers within the geographic area, and the displayable image conveys aggregated presence and locations of wireless communication subscribers within the second geographic area.

7. The method of claim 1, wherein said dynamic generation/pre-generation comprises generating a plurality of displayable sub-images, with each displayable sub-image corresponding to a sub-area of the second geographic area, and to be rendered using a plurality of pixels of a display of the wireless mobile station, the usage being functionally dependent on presence and locations of wireless communication subscribers in the corresponding sub-area of the second geographic area.

8. The method of claim 7, wherein each sub-area comprises one or more wireless communication cells within the second geographic area.

9. The method of claim 7, wherein said functional dependent usage of pixels of a sub-image comprises selectively illuminating a different quantities of the pixels based on presence and locations of wireless communications subscriber within the corresponding sub-area.

10. The method of claim 7, wherein said functional dependent usage of pixels of a sub-image comprises selectively illuminating the pixels to manifest different colors based on presence and locations of wireless communications subscriber within the corresponding sub-area.

11. The method of claim 1, wherein said dynamic generation/pre-generation of a displayable image comprises generating a landmark image as part of the generated displayable image.

12. The method of claim 11, wherein the landmark image comprises a selected one of a park, a stadium, a shopping mall and a campus.

13. A computing apparatus comprising:
storage medium having stored therein a plurality of programming instructions designed to
receive from a wireless mobile station a request for presence and locations of wireless communication subscribers for a first geographic area;
in response, perform one of
dynamically generating a displayable image that conveys presence and locations of wireless communication subscribers for a second geographic area substantially comprising the first geographic area, and
selecting a pre-generated displayable image that conveys presence and locations of wireless communication subscribers for a second geographic area substantially comprising the first geographic area, and
transmit the dynamically generated/selected displayable image to the wireless mobile station for display on the wireless mobile station; and
at least one processor coupled to the storage medium to execute the plurality of programming instructions.

14. The computing apparatus of claim 13, wherein the programming instructions are designed to perform said dynamic generation/pre-generation by
determining presence and locations of wireless communications subscribers within the second geographic area; and
generating the displayable image based on the determined presence and locations of wireless communication subscribers within the second geographic area.

15. The computing apparatus of claim 13, wherein the programming instructions are designed to perform said determining by accessing a home location register of a wireless communication service provider providing wireless communication service for the second geographic area.

16. The computing apparatus of claim 13, wherein the programming instructions are designed to perform said determining by accessing a visitor location register of a wireless communication service provider providing wireless communication service for the second geographic area.

17. The computing apparatus of claim 13, wherein the programming instructions are further designed to
receive one or more subscriber selection criteria, and
dynamically generate/pre-generate the displayable image further based on the provided subscriber selection criteria.

18. The computing apparatus of claim 13, wherein the programming instructions are further designed to aggregate presence and locations of wireless communication subscribers within the second geographic area, and the displayable image conveys aggregated presence and locations of wireless communication subscribers within the second geographic area.

19. The computing apparatus of claim 13, wherein the programming instructions are further designed to generate a plurality of displayable sub-images, with each displayable sub-image corresponding to a sub-area of the second geographic area, and to be rendered using a plurality of pixels of a display of the wireless mobile station, the usage being functionally dependent on the determined presence of wireless communication subscribers in the corresponding sub-area of the second geographic area.

20. The computing apparatus of claim 19, wherein each sub-area comprises one or more wireless communication cells within the second geographic area.

21. The computing apparatus of claim 19, wherein the programming instructions are designed to functionally use the pixels of a sub-image in a dependent manner by selectively illuminating a different quantities of the pixels based on presence and locations of wireless communications subscriber within the corresponding sub-area.

22. The computing apparatus of claim 19, wherein the programming instructions are designed to functionally use the pixels of a sub-image in a dependent manner by selectively illuminating the pixels to manifest different colors based on the presence and locations of wireless communications subscriber within the corresponding sub-area.

23. The computing apparatus of claim 13, wherein the programming instructions are designed to generate a landmark image as a part of the displayable image.

24. The computing apparatus of claim 23, wherein the landmark image comprises a selected one of a park, a stadium, a shopping mall and a campus

25. A wireless mobile station comprising:
storage medium having stored therein a plurality of programming instructions designed to
facilitate a user of the wireless mobile station in defining a first geographic area,
provide the definition of the geographic area to a server for the server to provide in response a displayable image that conveys presence and locations of wireless communication subscribers within a second geographic area that substantially comprises the first geographic area, and
receive the displayable image from the server; and
at least one processor coupled to the storage medium to execute the plurality of programming instructions.

26. The wireless mobile station of claim 25, wherein said facilitating comprises displaying a listing of geographic area names for the user to select.

27. The wireless mobile station of claim 25, wherein said facilitating comprises displaying a listing of geographic area icons for the user to select.

28. The wireless mobile station of claim 25, wherein said facilitating comprises facilitating the user in sketching the geographic area.

29. The wireless mobile station of claim 25, wherein said facilitating comprises facilitating the user in specifying at least three critical points of the geographic area.

30. The wireless mobile station of claim 25, wherein the wireless mobile station is a wireless mobile phone.

31. In a computing environment, a method of operation:
accessing at least one of a home location register and a visitor location register of a wireless communication service provider providing wireless communication service for a geographic area, for presence and locations of wireless communication subscribers within the geographic area;
processing the obtained presence and locations of wireless communication subscribers within the geographic area to generate a displayable image conveying the presence and locations of wireless communications subscribers within the geographic area; and
transmitting the generated displayable image to a wireless mobile station for display on the wireless mobile station.

32. The method of claim 1, wherein said generating comprises generating a plurality of displayable sub-images, with each displayable sub-image corresponding to a sub-area of the geographic area, and to be rendered using a plurality of pixels of a display of the wireless mobile station, the usage being functionally dependent on presence and locations of wireless communication subscribers in the corresponding sub-area of the geographic area.

33. The method of claim 32, wherein each sub-area comprises one or more wireless communication cells within the second geographic area, and said generating further comprises generating a landmark image as part of the generated displayable image.

34. The method of claim 32, wherein said functional dependent usage of pixels of a sub-image comprises selectively illuminating a different quantities of the pixels based on presence and locations of wireless communications subscriber within the corresponding sub-area.

35. The method of claim 32, wherein said functional dependent usage of pixels of a sub-image comprises selectively illuminating the pixels to manifest different colors based on presence and locations of wireless communications subscriber within the corresponding sub-area.

36. A computing apparatus:
storage medium having stored therein a plurality of programming instructions designed to
access at least one of a home location register and a visitor location register of a wireless communication service provider providing wireless communication service for a geographic area, for presence and locations of wireless communication subscribers within the geographic area,
process the obtained presence and locations of wireless communication subscribers within the geographic area to generate a displayable image conveying the presence and locations of wireless communications subscribers within the geographic area, and
transmit the generated displayable image to a wireless mobile station for display on the wireless mobile station; and
at least one processor coupled to the storage medium to execute the programming instructions.

37. The computing apparatus of claim 36, wherein the programming instructions are designed to perform said generating by generating a plurality of displayable sub-images, with each displayable sub-image corresponding to a sub-area of the geographic area, and to be rendered using a plurality of pixels of a display of the wireless mobile station, the usage being functionally dependent on presence and locations of wireless communication subscribers in the corresponding sub-area of the geographic area.

38. The computing apparatus of claim 37, wherein each sub-area comprises one or more wireless communication cells within the second geographic area, and said generating further comprises generating a landmark image as part of the generated displayable image.

39. The computing apparatus of claim 37, wherein the programming instructions are designed to dependently use the pixels of a sub-image by selectively illuminating a different quantities of the pixels based on presence and locations of wireless communications subscriber within the corresponding sub-area.

40. The computing apparatus of claim 37, wherein the programming instructions are designed to dependently use the pixels of a sub-image by selectively illuminating the pixels to manifest different colors based on presence and locations of wireless communications subscriber within the corresponding sub-area.
